(19) United States
(12) Patent Application Publication
(10) Pub. No.: US 2025/0038989 A1
(43) Pub. Date: Jan. 30, 2025

(54) SECURING ACCESS OF STORAGE ARRAY SERVICES

(71) Applicant: Dell Products L.P., Round Rock, TX (US)

(72) Inventors: EFI LEVI, Beer Sheva (IL); ARIEH DON, Newton, MA (US); LIOR BENISTY, Beer Sheva (IL)

(21) Appl. No.: 18/358,294

(22) Filed: Jul. 25, 2023

(51) Int. Cl. H04L 9/32; G06F 21/44; G06F 21/78; G06F 21/85

(52) U.S. Cl. CPC H04L 9/3247; G06F 21/44; G06F 21/78; G06F 21/85; G06F 2221/2129

(57) ABSTRACT

Methods and systems for securing access of storage array services are disclosed. The storage array services may be secured by responding to an inquiry from the host bus adapter of a host with a payload. The contents of the payload may require authentication by the host to enable access to the storage array. The contents of the payload may include one or more messages and a digital signature. The digital signature may be signed with a private key from the storage array and verified with a public key from the host. The messages may be authenticated using the digital signature and/or other messages in the payload. Should the any of the contents of the payload be unable to be authenticated by the host, the host bus adapter may be remediated for hardware errors of malicious activity.

### FIELD

Embodiments disclosed herein relate generally to device management. More particularly, embodiments disclosed herein relate to managing use of storage services.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a first data flow diagram illustrating operation of a portion of a system in accordance with an embodiment.

FIG. 2B shows a second data flow diagram illustrating operation of a portion of a system in accordance with an embodiment.

FIG. 2C shows a third data flow diagram illustrating operation of a portion of a system in accordance with an embodiment.

FIG. 3 shows a flow diagram illustrating a method of utilizing storage services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to the methods and systems for managing use of storage services provided by storage arrays. The use of storage services by hosts may be managed by limiting use of storage services to devices that may be authenticated.

To utilize storage services provided by storage arrays, hosts may communicate with the storage arrays using host bus adapters (HBAs). However, the HBAs may not be trustworthy. Consequently, Small Computer System Interface (SCSI) inquiries sent to the storage arrays and responses provided by the storage arrays may be subject to compromise by HBAs.

To secure communications between hosts and storage arrays, the hosts may require that responses from storage arrays be verified prior to use of storage services provided by the storage arrays. Verifiable responses may include one or more messages and a digital signature. The messages may include but not be limited to storage array information, a hash value of the storage array information, and a digital signature. The digital signature may be signed using a private key owned by the storage array.

Upon receiving a verifiable response, the host may verify the content of the response. For example, the digital signature may be verified with a public key corresponding to a private key used by the host. Once the digital signature may be verified, the digital signature may be used to verify the authenticity of the hash value. Once the hash value may be verified, a second hash value of the storage array information may be generated with a hashing algorithm. If the payload hash value may be found to match the host hash value, then the storage array information may be authenticated. Authentication of the storage array information, payload hash value, and digital signature may render storage array services accessible to the host.

By doing so, a host may be less likely to expose sensitive information to a malicious entity that intercepts it via a compromised HBA. The host may do so by requiring that responses to inquiries be verifiable for the content of the responses to be trusted.

In an embodiment, a method for managing use of storage services provided by a storage array is provided. The method may include (i) identifying an attachment of the storage array to a host; (ii) in response to identifying the attachment: (a) initiating, using a host bus adapter of the host, an inquiry to the storage array by the host, (b) receiving, using the host bus adapter of the host, a payload from the storage array by the host, the payload being responsive to the inquiry, (c) verifying the authenticity of the storage array information using the digital signature and a trusted public key, (d) utilizing storage services provided by the storage array in a first instance of the verifying wherein the storage array information can be verified as authentic, and (e) attempting to remediate the host bus adapter in a second instance of the verifying wherein the storage array information cannot be verified as authentic.

The payload may include storage array information and a digital signature, wherein the digital signature is generated using a private key.

The digital signature may be usable to verify authenticity of the storage array information.

Verifying the authenticity of the storage array information may include ingesting the digital signature, the storage array information, and a public key into a signature verification algorithm.

The payload may further include a hash value based on the storage array information.

The digital signature may be usable to verify authenticity of the hash value.

The hash value may be usable to verify authenticity of the storage array information.

Verifying the authenticity of the storage array information may include (i) ingesting the digital signature, the hash value, and a public key into a signature verification algorithm; and (ii) ingesting the storage array information into a hash value generation algorithm.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

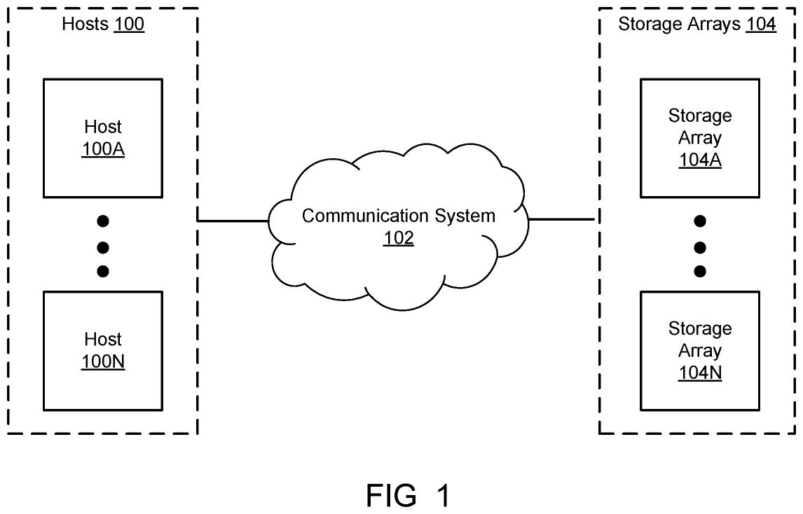

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

When the computer implemented services are performed, new data may be obtained and previously obtained data may be used. The new data may be stored in local and/or remote storage and previously obtained data may be accessed in the local and/or remote storage.

To facilitate use of remote storage (i.e., remote to a devices that is generating/accessing data), the system of FIG. 1 may include storage arrays 104. Storage arrays 104 may provide data management services and may be remote to the devices that generate and/or use data. The data management services may include storing data and providing access to previously stored data. Storage arrays may include any number of storage arrays (e.g., 104A-104N).

To utilize the data management services provided by storage arrays 104, hosts 101 may include adapters (e.g., host bus adapters (HBAs)) that facilitate communication between hosts 101 and storage arrays 104 via communication system 102. The adapters may provide for direct input-output (IO) processing by hosts 100 using storage arrays 104.

To utilize the data management services, the hosts may request that the adapters obtain information regarding various storage arrays reachable via adapters. For example, in the context of a small computer system interface (SCSI) implementations, hosts 100 may issue an inquiry to a storage array of the set of storage arrays 104. The storage array receiving the inquiry may respond with information regarding the storage array. This information may then be passed to a processing complex of the host.

The storage array may return a message that may include but not be limited to identification, make, and/or read capacity of the storage array. The processing complex of the host may then start to utilize storage services from the storage array using the information obtained through the adapter.

However, if the adapter becomes compromised by malware or operates in error, then the adapter may spoof or otherwise provide unreliable information to the processing complex of the host. For example, if infected by malware, the adapter may provide false information regarding storage arrays thereby enticing the processing complex to expose sensitive information (e.g., by attempting to store it in the storage array) to the adapter. The compromised adapter may then provide copies of the sensitive information to unauthorized entities. As a result of compromise by malware, the adapter may be used by a malicious party to access data that would otherwise not be made available under normal operation of the adapter.

In general, embodiments disclosed here relate to systems and methods for securing data stored in storage arrays. To secure the data, processing complexes of hosts and storage arrays may cooperate to limit the impact that adapters may have on data storage and access processes.

To limit the impact that adapters have on data storage and access processes, storage arrays 104 may add authentication data to responses to inquiries from processing complexes. The authentication data may allow the hosts to authenticate the responses.

For example, an adapter within a host may initiate a SCSI inquiry to a storage array. The storage array may receive the SCSI inquiry. In response to the SCSI inquiry, the storage array may generate a payload with a message and sign it with a digital signature. The storage array may then send the payload to the adapter.

Upon reception of the payload, the adapter may pass the payload to a processing complex. The processing complex may verify the digital signature, and then (presuming that the digital signature is verified) use the digital signature to verify the integrity of the message. Upon verification of the message of the payload, storage services provided by the storage array may be used by the processing complex.

As an example, a HBA from a host may initiate a SCSI inquiry to a storage array. In response, the storage array may generate a payload. The payload may include a message, a hash value of the message derived from a SHA-256 hashing algorithm, and a digital signature. The message may include but not be limited to the identification, make, and/or read capacity of the storage array. The digital signature may be signed using a private key and a signing algorithm.

The HBA may receive the payload from the storage array. To verify the digital signature, the processing complex may use a public key that may be available to the host (e.g., via a key manager not shown in FIG. 1 or another trusted entity). Once the signature is verified, the HBA may use a SHA-256 algorithm to generate a second hash value of the message. The hash value (verified as part of the signature check) from the payload and the new hash value may be compared to verify authenticity of the message. If the hashes match, the processing complex of the host may confirm the payload originated from the target storage array and has not been modified after generation. Upon confirmation, storage services from the storage array may be used by the processing complex (e.g., using, at least in part, the information regarding the storage array included in the payload).

By doing so, embodiments disclosed herein may reduce the likelihood of a compromised adapter impacting use of storage services provided by storage array. For example, by cryptographically verifying messages from the storage array a compromised adapter may be unable to direct input-output (IO) to a malicious entity by preventing spoofing of responses to inquiries by the processing complexes of hosts.

To provide the above noted functionality, the system may include hosts 100, storage array 104, and communication system 102. Each of the components is discussed below.

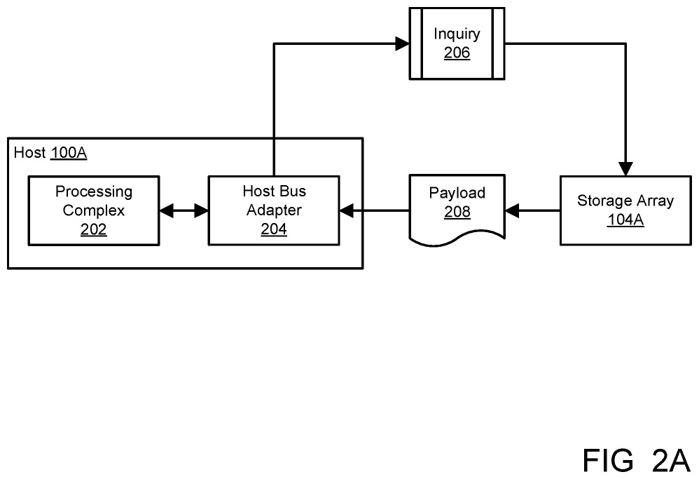

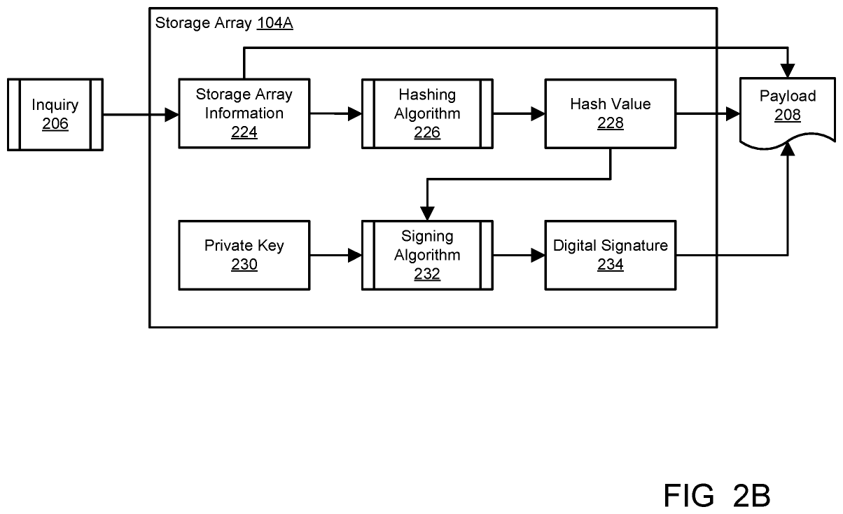

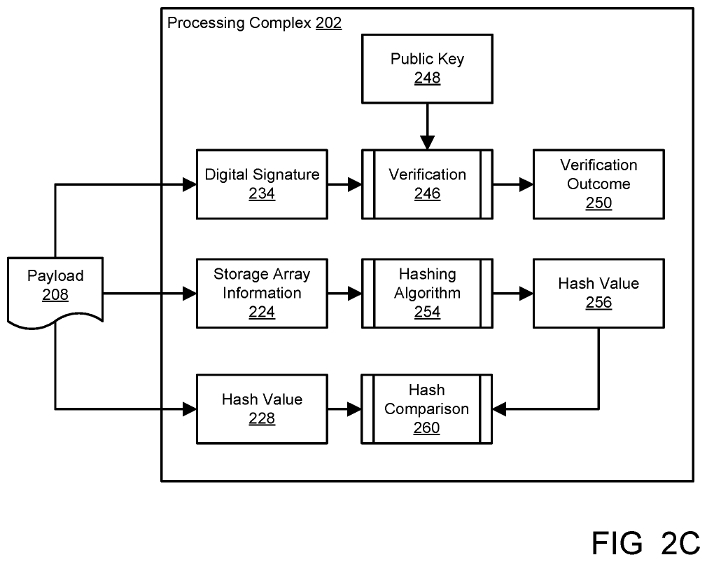

Hosts 100 may provide the computer implemented services, discussed above. To provide the computer implemented services, hosts 100 may utilize services provided by storage array 106 by directing IO to storage arrays. To utilize the services provided by storage arrays 104, any of hosts 100 may (i) send inquiries to the storage arrays, (ii) obtain responses to the inquiries, (iii) verify the responses, and (iv) use storage services provided by the storage arrays for which responses can be verified. Refer to FIG. 2A for additional details regarding storage services provided by storage array 106.

To verify the responses, hosts 100 may use information included in the responses to cryptographically verify the source of and integrity of the messages. Refer to FIG. 2C for additional details regarding authentication of messages from storage arrays 104 by hosts 100.

Storage arrays 104 may provide data storage services (e.g., storing data, deleting storage data, providing copies of stored data, etc.). To provide the data storage services, storage arrays 104 may (i) obtain inquiries from hosts, (ii) generate verifiable responses to the inquiries, and (iii) store data, delete data, provide copies of stored data, and/or otherwise respond to storage requests (e.g., IO) from hosts 100. The verifiable responses may include one or more messages and a digital signature. Refer to FIG. 2B for additional details regarding responding to inquiries.

Thus, as identified in FIG. 1, a system in accordance with an embodiment may validate responses allegedly from storage arrays prior to use of storage services provided by the storage arrays. By doing so, data used by

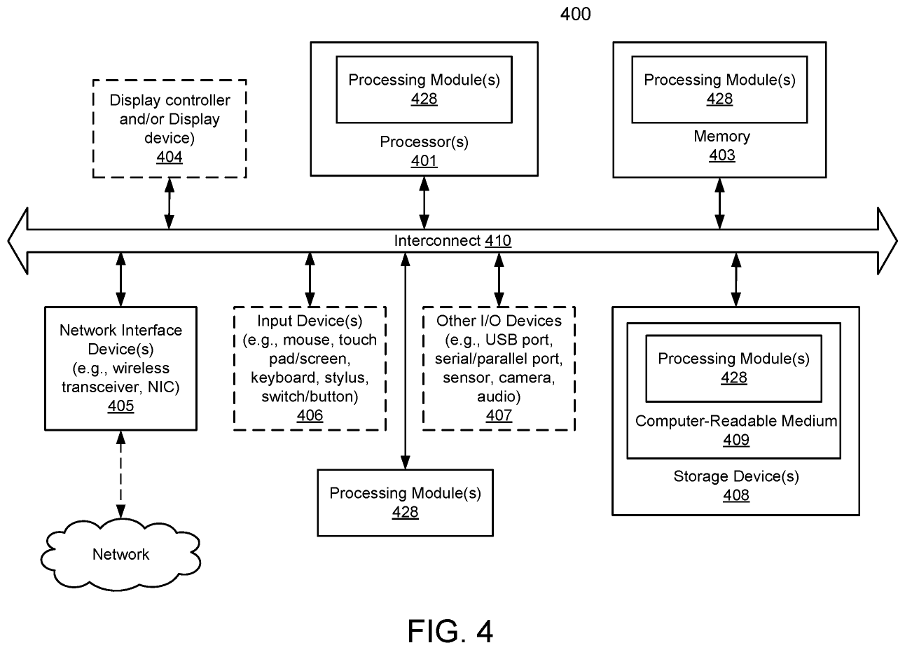

Any of (and/or components thereof) hosts 100 and storage arrays 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Storage arrays 104 may be implemented using any number of storage devices including, for example, hard disk drives, solid state storage devices, tape drives, storage controllers, and/or other devices that facilitate storage of data.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 102 may be implemented using a communication fabric and/or other communication architecture. The communication architecture may implement various protocols and interfaces including, for example, SCSI.

While illustrated in FIG. 1 as including a limited number of specific components, a system in accordance with an embodiment may include fewer, additional, and/or different components than those components illustrated therein.

To further clarify embodiments disclosed herein, data flow diagrams are shown in FIG. 2A-2C. These data flow diagrams show flows of data that may be implemented by the system of FIG. 1. In FIG. 2A, data flows between a host and storage array in accordance with an embodiment is shown. In FIG. 2B, data flows during payload generation in accordance with an embodiment is shown. In FIG. 2C, data flows during payload authentication in accordance with an embodiment is shown.

Turning to FIG. 2A, a first data flow diagram showing a data flow between host 100A and storage array 104A in accordance with an embodiment is shown. The flow may occur when host 100A initiates use of storage services provided by storage array 104A.

Host 100A may include processing complex 202 and host bus adapter 204. Processing complex may host an application that needs to store data. To do so, processing complex 202 may use storage services provided by storage arrays.

storage array 104A to initiate use of storage services provided by storage array 104A, host 104A may utilize host bus adapter 204 to generate and send inquiry 206 to storage array 104A. Inquiry 206 may inquire for identification, make, and/or read capacity of storage array 104A. This information may allow the application hosted by processing complex 202 to decide whether storage array 104A is a good candidate for storage of data.

Storage array 104A may respond to host 104A with payload 208. Payload 208 may include one or more messages and a digital signature from storage array 104A. Host bus adapter 204 may receive payload 208 and pass it to processing complex 202 for authentication. Processing complex 202 may include any number and type of processors, memory, and/or other hardware necessary for the function of host 104A.

Processing complex 202 may host applications usable to verify the digital signature of payload 208, followed by verifying one or more messages in payload 208. Should verification of the digital signature and all messages be successful, host 104A may initiate use of storage services provided by storage array 104A. Conversely, should verification of the digital signature and/or all messages not be successful, processing complex 202 may conclude that host bus adapter 204 is untrustworthy. If found untrustworthy, processing complex 202 may initiate remediation of host bus adapter 204. Host bus adapter 204 may be remediated by (i) scanning or otherwise analyzing host bus adapter 204 for malicious entities or other signs of compromise, signs of damage, and/or signs of other conditions impacting host bus adapter 204, and (ii) initiate action to place host bus adapter 204 in nominal operating condition. For example, if found to host a malicious application, antivirus or other applications may be used to purge the malicious application and repair host bus adapter 204. If unable to repair host bus adapter 204, processing complex 202 may at least temporarily stop using host bus adapter 204 until it can be repaired or otherwise placed in nominal operating condition (e.g., operating condition within expected thresholds).

Host bus adapter 204 may be implemented using a hardware device. The hardware device may be responsible for connecting processing complex 202, to a network storage system, such as storage arrays 104 in FIG. 1. Host bus adapter 204 may manage services and tasks between processing complex 202 and storage arrays 104. The type of connectivity supplied by host bus adapter 204 may include fibre channel (FC), SCSI, Serial Attached SCSI (SAS), Serial Advanced Technology Attachment, and/or other types of connections between processing complexes and storage arrays.

Inquiry 206 may be implemented one or more data structures. The data structures may include commands (e.g., natively executable and/or invokes commands indirectly) to obtain information about a storage array. The information may include identification information (e.g., identifiers), makes, capacity, and/or other information regarding the storage array that may allow a requestor to better use storage services provided by the storage array.

However, if host bus adapter 204 is compromised with malware, then the malware may spoof responses to inquiry 206. When processing complex 202 initiates sending of inquiry 206, the malware may spoof a response to inquiry 206, thereby giving the appearance of sending inquiry 206 to a storage array and receiving a response (e.g., payload 208).

Because a response to inquiry 206 may be spoofed, processing complex 202 may not trust a response unless it can be verified. To enable authentication of responses to inquiries, payload 208 may be generated by storage array 104A.

Payload 208 may be implemented using one or more data structures. The data structures may be generated by storage array 104A. Storage array 104A may populate payload 208 with one or more messages and a digital signature. All messages and the digital signature may be verified by processing complex 202 in host 104A.

Thus, as seen in FIG. 2A, a processing complex of a host in accordance with an embodiment may verify responses to inquires prior to using storage services provided by the storage arrays that generated the responses. By doing so, the processing complexes may be less likely to expose sensitive data to malicious parties.

To reduce the likelihood of exposing sensitive data to malicious parties, responses to inquires may need to include authentication data for the messages that include information regarding storage arrays.

Turning to FIG. 2B, a second data flow diagram showing a data flow that may occur during payload generation in accordance with an embodiment is shown.

Payload 208 generation may be initiated when inquiry 206 is obtained by storage array 104A. Upon receipt of inquiry 220, may begin generation of payload 208.

Generation of payload 208 may begin with packaging of storage array information 224 in payload 224. In addition, storage array information 224 may be ingested by hashing algorithm 226, which may produce hash value 228. Hash value 228 may also be packaged in payload 208. Finally, hash value 228 may be ingested by signing algorithm 232, which may utilize private key 230 to develop digital signature 234. Digital signature 234 may also be packaged in payload 208.

Thus, payload 208 may include storage array information 224, hash value 228 (e.g., usable to verify the integrity of storage array information 224), and digital signature 234 (e.g., usable to verify the integrity of hash value 228 and authenticate the entity alleged to have generated payload 208).

Storage array information 224 may be implemented using a data structure. The data structure may include identifiers of, make of, read capacity of, and/or other information regarding storage array 224.

Hashing algorithm 226 may be implemented using a process. The process may map a binary string of arbitrary length to a binary string of a fixed length. Types of hashing algorithm 226 may include but not be limited to MD-5, RACE Integrity Primitives Evaluation Message Digest (RIPEMD-160), SHA, SHA-256, and Whirlpool. Implementation of hashing algorithm 226 may yield hash value 228.

Hash value 228 may be implemented using a data structure. The data structure may be a fixed-size binary encoded from an arbitrary binary string. The encoding may be from a one-way process so hash value 228 may not be reverted to obtain the plain text.

Signing algorithm 232 may implemented using a process. The process may facilitate digitally signing a data structure. Signing algorithm may utilize private key 230 for the production of digital signature 234 (e.g.) with a timestamp) to verify hash value 228.

Private key 230 may be implemented using a data structure. Private key 230 may be associated with a public key but may be separate from the public key within the system of FIG. 1 (e.g., copies of the public key may be freely distributed, while private key 230 may be kept secret). Signing algorithm 232 may use private key 230 to produce digital signature 234.

Digital signature 234 may be implemented using a data structure. The data structure may facilitate verification of hash value 228 and that private key 230 was used to generate digital signature 234. Therefore, digital signature 234 may be usable to verify that hash value 228 is not altered after production of digital signature 234.

Payload 208 may be implemented using a data structure, and may be generated through aggregation of the components discussed in FIG. 2B. While shown in FIG. 2B as including storage array information, hash value 228, and digital signature 234, a payload in accordance with an embodiment may only include storage array information 224 and digital signature 234. In such a case, storage array information 224 may be ingested by signing algorithm 232 rather than ingesting hash value 228.

Thus, as seen in FIG. 2B, a cryptographically verifiable payload may be generated. Payload 208 may be used by a processing complex to establish trust in storage services provided by storage array 104A.

Turning to FIG. 2C, a third data flow diagram showing a data flow used to establish trust in storage services provided by storage array 104A in accordance with an embodiment is shown. Once payload 208 is obtained by processing complex 202, the authenticity of payload 208 may be verified prior to using storage array information 252.

To verify payload 208, digital signature 234 may be ingested by verification 246 process along with public key 248. Verification 246 may use public key 248 to attempt to verify the sources of digital signature 234 and authenticity of hash value 228. Verification outcome 250 may indicate whether the source of and hash value 228 from payload 208 can be verified.

If verification outcome 250 indicates that the source of payload 208 is trustworthy and that hash value 228 has not been modified, storage array information 224 may be extracted from payload 208. Hash value 256 may be generated from storage array information 252 using hashing algorithm 254. Hashing algorithm 254 may be similar to hashing algorithm 226 in FIG. 2B. Also, hash value 228 may be extracted from payload 208. Hash comparison 260 may ingest hash value 256 and hash value 228 to compare both values.

If both hash value 256 and hash value 228 are identical and verification outcome 250 may be verified, then storage array information 224 may be treated as being trustworthy. Consequently, storage services from storage array 104A may be used by processing complex 202. Otherwise, storage array information 224 may not be trusted and host bus adapter 204 may be treated as being suspected of being compromised. If suspected of being compromised, various remediation actions may be performed for host bus adapter 204 to search for hardware errors or malicious activity.

Public key 248 may be implemented using a data structure. The data structure may reside on one or more components of processing complex 202 and/or be reachable by processing complex 202 without relying on host bus adapter 204. The corresponding private key to public key 248 may be private key 230 in FIG. 2B. Public key 248 may be used in verification 246 of digital signature 244.

Verification 246 may be implemented using a process. The process may ingest digital signature 244 and public key 248, and may be a signature verification algorithm.

Verification outcome 250 may be implemented using a data structure. The data structure may include the verification status for digital signature 234. If verification outcome 250 may yield an unverified status, then authentication on contents in payload 208 may end and remediation of host bus adapter 204 in FIG. 2A may begin. Otherwise, if verification outcome 250 may yield a verified status, then authentication of the contents of payload 208 may continue.

Thus, as shown in FIG. 2C, payloads may be authenticated and used as a prerequisite to use of storage services provided by storage arrays. Consequently, processing complexes may be less likely to expose sensitive data to unauthorized entities.

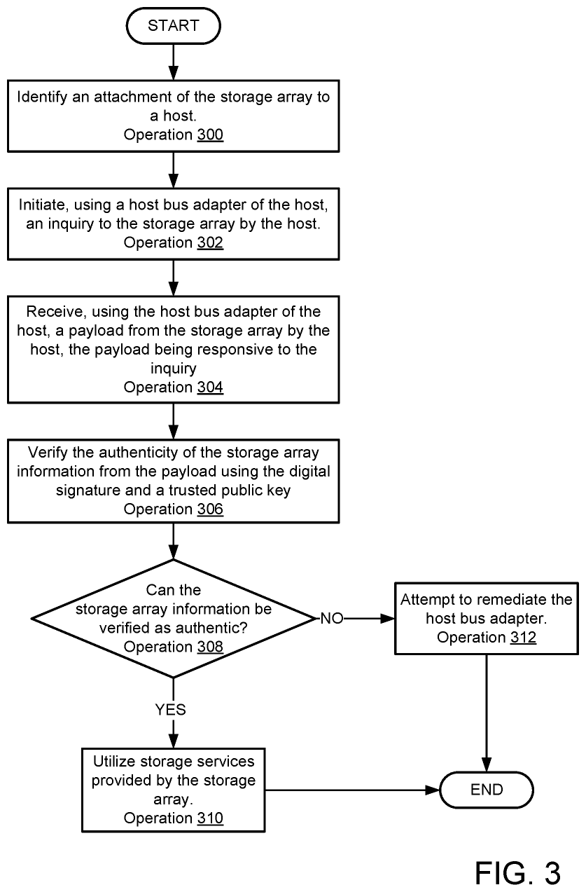

As discussed above, the components of FIG. 1 may perform various methods to manage operations on hosts 100 and storage arrays 104. FIG. 3 illustrates a method that may be performed by the components of FIG. 1. In the diagrams discussed below and shown in FIG. 3, any of the operations may be repeated, performed in different orders, and/or performed in parallel with and/or in a partially overlapping in time manner with other operations.

Turning to FIG. 3, a flow diagram illustrating a method of establishing use of storage services provided by storage arrays in accordance with an embodiment is shown. The method may be performed, for example, by one or more of hosts 100, storage arrays 104, and/or other components of the system of FIG. 1.

At operation 300, an attachment of the storage array to a host may be identified. The attachment may be identified by receiving a message from a host bus adapter. The host bus adapter may be connected to the storage array. The host bus adapter may send a message to a processing complex when the storage array becomes reachable via the host bus adapter.

At operation 302, an inquiry may be initiated, using a host bus adapter of the host, to the storage array by the host. An inquiry may be initiated by executing a SCSI inquiry (or other type of protocol compliant inquiry) from the host bus adapter to the storage array.

At operation 304, a payload may be received using the host bus adapter of the host. The payload may be responsive to the inquiry. The payload may be received by the host bus adapter, which may forward the payload to a processing complex.

At operation 306, the authenticity of the storage array information from the payload may be verified using the digital signature from the payload and a trusted public key. The authenticity of the storage array information may be verified by ingesting the digital signature, the hash value from the payload, and a public key (of a trusted entity, the storage array) into a signature verification algorithm. The storage array information may be ingested into a hash value generation algorithm. The storage array information may be ingested by generating a second hash value for the storage array information and matching the second hash value against the first hash value. If the signature can be validated and the hashes match, then the storage array information from the payload may be treated as being authentic.

At operation 308, a determination may be made regarding whether the storage array can be verified as authentic. The determination may be made by verifying the authenticity of the contents of the payload, as described with respect to operation 306.

If the storage array information can be verified as authentic, then the method may proceed at operation 310. If the storage array cannot be verified as authentic, then the method may proceed at operation 312.

At operation 312, storage services provided by the storage array may be utilized. The storage service may be utilized by providing access to the storage array using content of the payload.

At operation 314, one or more attempts to remediate the host bus adapter may be made. The attempts to remediate may be made by running internal software or hardware to search for errors or malicious activity in the host bus adapter, by notifying administrators, and/or by performing other processes.

The method may end following operation 310 or 312.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing use of storage services provided by a storage array, the method comprising:
identifying an attachment of the storage array to a host;
in response to identifying the attachment:
initiating, using a host bus adapter of the host, an inquiry to the storage array by the host;
receiving, using the host bus adapter of the host, a payload from the storage array by the host, the payload being responsive to the inquiry and comprising storage array information and a digital signature;
verifying authenticity of the storage array information using the digital signature and a trusted public key;
in a first instance of the verifying wherein the storage array information can be verified as authentic:
utilizing storage services provided by the storage array;
in a second instance of the verifying wherein the storage array information cannot be verified as authentic:
attempting to remediate the host bus adapter.

2. The method of claim 1, wherein the payload comprises storage array information and a digital signature, wherein the digital signature is generated using a private key.

3. The method of claim 2, wherein the digital signature is usable to verify authenticity of the storage array information.

4. The method of claim 3, wherein verifying the authenticity of the storage array information comprises:
ingesting the digital signature, the storage array information, and a public key into a signature verification algorithm.

5. The method of claim 2, wherein the payload further comprises a hash value based on the storage array information.

6. The method of claim 5, wherein the digital signature is usable to verify authenticity of the hash value.

7. The method of claim 6, wherein the hash value is usable to verify authenticity of the storage array information.

8. The method of claim 7, wherein verifying the authenticity of the storage array information comprises:
ingesting the digital signature, the hash value, and a public key into a signature verification algorithm; and
ingesting the storage array information into a hash value generation algorithm.

9. A non-transitory machine-readable medium having instructions stored therein, which when executed by a processor, cause the processor to perform operations for managing use of storage services provided by a storage array, the operation comprising:
identifying an attachment of the storage array to a host;
in response to identifying the attachment:
initiating, using a host bus adapter of the host, an inquiry to the storage array by the host;
receiving, using the host bus adapter of the host, a payload from the storage array by the host, the payload being responsive to the inquiry and comprising storage array information and a digital signature;
verifying authenticity of the storage array information using the digital signature and a trusted public key;
in a first instance of the verifying wherein the storage array information can be verified as authentic:
utilizing storage services provided by the storage array;
in a second instance of the verifying wherein the storage array information cannot be verified as authentic:
attempting to remediate the host bus adapter.

10. The non-transitory machine-readable medium of claim 9, wherein the payload comprises storage array information and a digital signature, wherein the digital signature is generated using a private key.

11. The non-transitory machine-readable medium of claim 10, wherein the digital signature is usable to verify authenticity of the storage array information.

12. The non-transitory machine-readable medium of claim 11, wherein verifying the authenticity of the storage array information comprises:
ingesting the digital signature, the storage array information, and a public key into a signature verification algorithm.

13. The non-transitory machine-readable medium of claim 10, wherein the payload further comprises a hash value based on the storage array information.

14. The non-transitory machine-readable medium of claim 13, wherein the digital signature is usable to verify authenticity of the hash value.

15. A data processing system, comprising:
a processor; and
a memory coupled to the processor to store instructions, which when executed by the processor, cause the processor to perform operations for managing use of storage services provided by a storage array, the operations comprising:
identifying an attachment of the storage array to a host bus adapter of the host;
in response to identifying the attachment:
initiating, using the host bus adapter of the host, an inquiry to the storage array by the host;
receiving, using the host bus adapter of the host, a payload from the storage array by the host, the payload being responsive to the inquiry and comprising storage array information and a digital signature;
verifying authenticity of the storage array information using the digital signature and a trusted public key;
in a first instance of the verifying wherein the storage array information can be verified as authentic:
utilizing storage services provided by the storage array;
in a second instance of the verifying wherein the storage array information cannot be verified as authentic:
attempting to remediate the host bus adapter.

16. The data processing system of claim 15, wherein the payload comprises storage array information and a digital signature, wherein the digital signature is generated using a private key.

17. The data processing system of claim 16, wherein the digital signature is usable to verify authenticity of the storage array information.

18. The data processing system of claim 17, wherein verifying the authenticity of the storage array information comprises:
ingesting the digital signature, the storage array information, and a public key into a signature verification algorithm.

19. The data processing system of claim 16, wherein the payload further comprises a hash value based on the storage array information.

20. The data processing system of claim 19, wherein the digital signature is usable to verify authenticity of the hash value.
